(19) United States
(12) Patent Application Publication
(10) Pub. No.: US 2019/0379049 A1
(43) Pub. Date: Dec. 12, 2019

(54) BINDER FOR ELECTROCHEMICAL ELEMENT

(71) Applicant: IDEMITSU KOSAN CO., LTD., Chiyoda-ku, Tokyo (JP)

(72) Inventor: Yu ISHIHARA, Sodegaura-shi (JP)

(73) Assignee: IDEMITSU KOSAN CO., LTD., Chiyoda-ku, Tokyo (JP)

(21) Appl. No.: 16/463,701

(22) PCT Filed: Nov. 14, 2017
(86) PCT No.: PCT/JP2017/040953

§ 371 Date: May 23, 2019

(30) Foreign Application Priority Data
Nov. 25, 2016 (JP) 2016-229012

(51) Int. Cl. H01M 4/62; H01M 10/0525; H01M 2/16; H01G 11/38

(52) U.S. Cl. CPC H01M 4/622; H01M 10/0525; H01G 11/38; H01M 2/1653; H01M 2/1686

(57) ABSTRACT

A binder for an electrochemical element, containing a polymer having both an anionic unit and a nonionic unit, wherein a part of the anionic unit is neutralized, and a degree of neutralization of the anionic unit in the polymer is 95% or less. Optionally, the anionic unit in the polymer is a carboxyl group, a sulfo group, a phosphonate group, a phosphinate group or a phosphate group.

### TECHNICAL FIELD

The invention relates to a binder for an electrochemical element.

### BACKGROUND ART

A secondary battery is a battery capable of being repeatedly charged and discharged, and use thereof is advancing not only in an electronic device such as a cellular phone and a laptop computer but also in a field of an automobile, aircraft or the like. In response to such a growing demand for the secondary battery, researches have been actively conducted. In particular, a lithium-ion battery that is lightweight, compact and has high energy density among the secondary batteries has attracted attention from each industrial world, and has been enthusiastically developed.

The lithium-ion battery is mainly composed of a positive electrode, an electrolyte, a negative electrode, and a separator. Among the materials, as the electrode, a material prepared by coating an electrode composition on a current collector is used.

Among the electrode compositions, a positive electrode composition used for forming the positive electrode is mainly composed of a positive electrode active material, a conductive auxiliary agent, a binder, and a solvent. Polyvinylidene fluoride (PVDF) and N-methyl-2-pyrrolidone (NMP) are generally used as the binder and the solvent, respectively. The reason is that PVDF is chemically and electrically stable, and NMP is a solvent which dissolves PVDF and has stability over time.

However, while a low molecular weight product of PVDF has a problem of insufficient adhesion, if a molecular weight of PVDP is increased, a dissolution concentration is not high, and therefore PVDF having a high molecular weight has a problem of difficulty in increasing a solid content concentration. Moreover, NMP has a high boiling point, and therefore if NMP is used as the solvent, NMP has a problem of requiring a large quantity of energy for volatilizing the solvent during forming the electrode. In addition thereto, an aqueous material without using an organic solvent has been recently required also for the electrode composition under a background of a growing concern for environmental issues.

In Non-Patent Document 1, polyacrylic acid (PAA) is examined as the binder for the positive electrode, in which a conductive path cannot be sufficiently secured, while the electrode can be constructed with an aqueous system, and therefore such an art has a problem of reduction of rate characteristics and cycle characteristics.

### RELATED ART DOCUMENT

### Non-Patent Document

Non-Patent Document 1: Journal of Power Sources 247 (2014) 1-8

### SUMMARY OF THE INVENTION

The present invention provides a binder for an electrochemical element, the binder having high dispersibility, and from which the electrochemical element excellent in rate characteristics and life characteristics can be prepared.

The present invention provides a binder for an electrochemical element, and the like as described below.

1. A binder for an electrochemical element, containing a polymer having both an anionic unit and a nonionic unit,

wherein a part of the anionic unit is neutralized, and a degree of neutralization of the anionic unit in the polymer is 95% or less.

2. The binder for the electrochemical element according to 1, wherein the anionic unit is a carboxyl group, a sulfo group, a phosphonate group, a phosphinate group or a phosphate group.

3. The binder for the electrochemical element according to 1 or 2, wherein a cation that neutralizes the anionic unit is an alkali metal ion or an alkaline earth metal ion.

4. The binder for the electrochemical element according to any one of 1 to 3, wherein the nonionic unit is an ester bond of a carboxyl group, a sulfo group, a phosphonate group or a phosphinate group, a carboxylic acid amide bond, a hydroxy group or an ether bond.

5. The binder for the electrochemical element according to any one of 1 to 4, wherein a mole ratio of the anionic unit to the nonionic unit is 2:8 to 8:2.

6. The binder for the electrochemical element according to any one of 1 to 5, wherein the polymer is a polymer having an anionic unit and a nonionic unit in a same repeating unit, and the same repeating unit occupies 50% or more of all the repeating units.

7. The binder for the electrochemical element according to any one of 1 to 6, wherein the repeating unit containing an aromatic hydrocarbon group contained in the polymer occupies 20% or less of all the repeating units.

8. The binder for the electrochemical element according to any one of 1 to 7, wherein the polymer is a polyamide containing a repeating unit having a carboxylic acid amide bond.

9. The binder for the electrochemical element according to any one of 1 to 8, wherein the polymer is a polymer containing a repeating unit represented by the following formula (1):

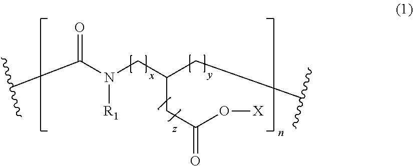

wherein, in the formula (1), x is an integer of 0 or more and 5 or less, y is an integer of 1 or more and 7 or less, and z is an integer of 0 or more and 5 or less;

X is a hydrogen ion, an alkali metal ion or an alkaline earth metal ion;

R₁ is a hydrogen atom or a functional group having 10 or less carbon atoms; and

n is a repeating number.

10. The binder for the electrochemical element according to any one of 1 to 9, wherein the polymer is a polymer containing 50% or more of repeating unit composed of amino acid or a neutralized product of amino acid.

11. The binder for the electrochemical element according to any one of 1 to 10, wherein 50% or more of the repeating unit of the polymer is a polymer composed of glutamic acid or a neutralized product of glutamic acid, or aspartic acid or a neutralized product of aspartic acid.

12. The binder for the electrochemical element according to any one of 1 to 11, wherein the polymer is poly-γ-glutamic acid or a neutralized product of poly-γ-glutamic acid.

13. The binder for the electrochemical element according to any one of 1 to 12, wherein a weight-average molecular weight (Mw, polyethylene glycol equivalent) of the polymer is 50,000 to 9,000,000.

14. The binder for the electrochemical element according to any one of 1 to 13, further containing water.

15. An electrode composition, containing the binder for the electrochemical element according to any one of 1 to 14.

16. An electrode, containing the binder for the electrochemical element according to any one of 1 to 14.

17. An electrochemical element, wherein the binder for the electrochemical element according to any one of 1 to 14 is used.

18. The electrochemical element according to 17, wherein the electrochemical element is a lithium-ion battery containing the binder for the electrochemical element in one or more selected from an electrode, a separator protective layer and an electrode protective layer, or is an electric double-layer capacitor containing the binder for the electrochemical element in the electrode.

The present invention can provide a binder for an electrochemical element, the binder having high dispersibility, and from which the electrochemical element excellent in rate characteristics and life characteristics can be prepared.

### BRIEF DESCRIPTION OF THE DRAWINGS

FIG. 1 shows a schematic cross-sectional view of a secondary battery of the present invention.

### MODE FOR CARRYING OUT THE INVENTION

### Binder for Electrochemical Element

A binder for an electrochemical element according to the present invention contains a polymer having both an anionic unit and a nonionic unit. In the polymer, a part of the anionic unit is neutralized, and a degree of neutralization of the anionic unit in the polymer is 95% or less.

A term “electrochemical element” herein means an element including a secondary battery such as a lithium-ion battery, and a capacitor.

Hereinafter, the polymer having both the anionic unit and the nonionic unit, in which a part of the anionic unit is neutralized and the degree of neutralization of the anionic unit is 95% or less, is referred to as “the polymer of the present invention” in several cases.

Specific examples of the anionic unit of the polymer of the present invention include a structure containing one or more selected from a carboxyl group, a sulfo group, a phosphonate group, a phosphinate group and a phosphate group.

The anionic unit is preferably a carboxyl group, a sulfo group, a phosphonate group, a phosphinate group or a phosphate group, and above all, a carboxyl group is further preferable. Acidity can be moderately adjusted by applying the carboxyl group as the anionic unit, and an active material and a current collector described later are free from risk of being corroded.

In the anionic unit in the polymer of the present invention, a part of the anionic unit is neutralized into a salt of the anionic unit. The degree of neutralization of the anionic unit in the polymer is defined as a ratio: (salt of anionic unit)/(non-neutralized anionic unit+salt of anionic unit), and the degree of neutralization of the anionic unit in the polymer is 95% or less.

The non-neutralized anionic unit neutralizes remaining alkali in the active material by adjusting the degree of neutralization of the anionic unit to 95% or less, and prevention of corrosion of an aluminum current collector can be expected.

The polymers having both the anionic units and the nonionic units in the binder may have two or more kinds. On the occasion, with regard to the degree of neutralization, an average value of the degree of neutralization of two or more kinds of the polymers may be 95% or less.

The degree of neutralization of the anionic unit in the polymer is preferably 90% or less, 80% or less, 70% or less, 60% or less and 55% or less in this order. Moreover, a lower limit of the degree of neutralization is not particularly limited, but is 20% or more, for example, and preferably 30% or more. For example, when the anionic unit is the carboxyl group, if the degree of neutralization is 20% or more, the polymer is expected to have sufficient water solubility.

The degree of neutralization of the anionic unit can be calculated by confirming an element ratio according to elemental analysis (a CHN corder method and ICP atomic emission spectroscopy) described in Examples.

A cation that neutralizes the anionic unit of the polymer is preferably an alkali metal ion or an alkaline earth metal ion, further preferably an alkali metal ion, and particularly preferably a Na ion or a Li ion.

If the cation that neutralizes the anionic unit is the Na ion, the polymer can be manufactured particularly inexpensively, and if the cation that neutralizes the anionic unit is the Li ion, the cation can be expected to contribute to reduction of charge transfer resistance between the electrolytic solution and the active material or to an improvement in lithium conductivity within the electrode.

The nonionic unit means a nonionic molecular skeleton having neither anionic properties nor cationic properties. The nonionic unit can be formed into one unit forming a nonionic dispersing agent, and specific examples of the nonionic unit can include a polymer-based nonionic dispersing agent such as polyvinyl pyrrolidone, polyvinyl alcohol, polyacrylamide, poly-N-vinylacetamide and polyalkylene glycol.

Specific examples of the nonionic unit include an ester structure such as acrylic acid ester and methacrylic ester, a polyoxyalkylene structure, a structure formed of a monomer having a hydroxy group, a structure formed of a monomer having an amide group, and an ether structure.

The nonionic unit is preferably an ester bond of a carboxyl group, a sulfo group, a phosphonate group or a phosphinate group, a carboxylic acid amide bond, a hydroxy group or an ether bond.

Here, the carboxylic acid amide bond includes primary to tertiary carboxylic acid amide bonds.

The polymer of the present invention has both the anionic unit and the nonionic unit.

The anionic unit and the nonionic unit may exist each independently in the repeating units different from each other, or both may exist in one repeating unit. For example, poly-γ-glutamic acid and a neutralized product of poly-γ-glutamic acid simultaneously have a carboxyl group, which is the anionic unit, and an amide group, which is the nonionic unit, in one repeating unit. In addition thereto, poly-α-glutamic acid, poly-β-aspartic acid, poly-α-aspartic acid or the like is also the polymer having both the anionic unit and the nonionic unit in one repeating unit.

The repeating unit containing the anionic unit in the polymer of the present invention occupies preferably 30% or more, further preferably 50% or more, and still further preferably 70% or more of all the repeating units of the polymer.

The polymer containing a large amount of the anionic unit has high polarity and can realize satisfactory bindability with metal foil, the active material and a conductive auxiliary agent, and simultaneously has a dispersion function and a thickening function. A composition containing the polymer having the anionic unit as the binder can exhibit good coating property.

The repeating unit containing the nonionic unit in the polymer of the present invention occupies preferably 30% or more, further preferably 50% or more, and still further preferably 70% or more of all the repeating units of the polymer.

The polymer of the present invention preferably has an amide group and/or an amide bond in the repeating unit as the nonionic unit. The repeating unit having a moiety of the amide group and/or the amide bond in the polymer occupies preferably 30% or more, further preferably 50% or more, and particularly preferably 70% or more of all the repeating units of the polymer.

If the repeating unit having the moiety of the amide group and/or the amide bond occupies 30% or more, the moiety of the amide group in the polymer forms a hydrogen bond to suppress dissolution of the polymer into the electrolytic solution, and simultaneously to form a network by the hydrogen bond, and thus strong holding of the active material can be expected. Moreover, a structural change caused by pH is not caused, as is different from an anionic dispersing agent unit, and therefore a stable dispersion effect to a change in pH can be expected.

In the polymer of the present invention, a mole ratio of the anionic unit to the nonionic unit is preferably 2:8 to 8:2. The mole ratio of the anionic unit to the nonionic unit is further preferably 3:7 to 7:3, and still further preferably 4:6 to 6:4.

Stable dispersibility can be expected to be obtained, while features of the anionic unit are maintained, by satisfying the above-described ratio in the mole ratio of the anionic unit to the nonionic unit, even if the anionic unit is protonated or neutralized by the change in pH.

The polymer of the present invention has preferably 20% or more, further preferably 30% or more, still further preferably 50% or more, and particularly preferably 70% or more of the repeating unit having a structure in which the anionic units and the nonionic units are alternately arranged. Generation of local aggregation caused by the change in pH can be suppressed by alternate existence of the anionic units and the nonionic units.

When the polymer of the present invention is the polymer having the anionic unit and the nonionic unit in the same repeating unit, the repeating unit having both the anionic unit and the nonionic unit occupies preferably 50% or more, and further preferably 70% or more of all the repeating units.

In the polymer of the present invention, the repeating unit containing an aromatic hydrocarbon group occupies preferably 20% or less, further preferably 15% or less, and particularly preferably 10% or less, based on a total.

Accordingly as a moiety of the aromatic hydrocarbon group contained in the polymer is smaller, the polymer is further free from risk of a change in a molecular weight, or gas generation by oxidative degradation of the polymer caused by oxidation of the aromatic hydrocarbon group.

The polymer of the present invention is preferably a polyamide containing a repeating unit having a carboxylic acid amide bond, further preferably a polymer having an amide group moiety and/or an amide bond in a main chain and having a carboxyl group moiety and/or a carboxylate group moiety in a side chain, and still further preferably a polymer containing the repeating unit represented by the following formula (1):

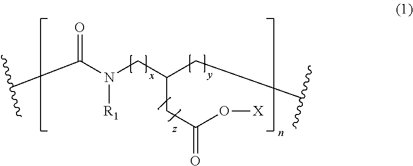

(in the formula (1), x is an integer of 0 or more and 5 or less, y is an integer of 1 or more and 7 or less, and z is an integer of 0 or more and 5 or less;

X is a hydrogen ion or a metal ion;

R₁ is a hydrogen atom or a functional group having 10 or less carbons; and

n is a repeating number.).

In the formula (1), x, y and z are preferably: x is an integer of 0 or more and 3 or less; y is an integer of 1 or more and 4 or less; and z is an integer of 0 or more and 3 or less, and further preferably: x is an integer of 0 or more and 1 or less; y is an integer of 1 or more and 2 or less; and z is an integer of 0 or more and 1 or less.

If a numerical value of x, y and z each is within the above-described range, an aliphatic skeleton can exhibit flexibility, the flexibility of the resulting electrode can be maintained, and the aliphatic skeleton, which is a hydrophobic moiety, is sufficiently small relative to an amide moiety and the carboxyl group or the carboxylate group moiety, which is a hydrophilic moiety, and the solubility in water can be ensured.

X is a hydrogen ion or a metal ion. The metal ion is preferably an alkali metal ion or an alkaline earth metal ion, and further preferably a Li ion or a Na ion. Moreover, a part of X may be an aliphatic hydrocarbon group, which means that a part of X is esterified. A percentage content of an esterified unit structure is preferably 70% or less, further preferably 50% or less, and particularly preferably 30% or less, based on a total. If the percentage content is 70% or less based on the total, the water solubility of the polymer is sufficiently developed. Moreover, specific examples of an ester include a methyl ester and an ethyl ester, in which X is a methyl group and an ethyl group, but are not limited thereto.

R₁ is a hydrogen atom or a functional group having 10 or less carbon atoms. The functional group includes an alkyl group, an alkoxyalkyl group, and a hydroxyalkyl group. Specific examples of the functional group having 10 or less carbon atoms include a methyl group, an ethyl group, a straight-chain or branched butyl group, pentyl group, or methoxymethyl group. The number of carbon atoms in the functional group is preferably 10 or less, further preferably 7 or less, and particularly preferably 5 or less. Moreover, R₁ may have a functional group forming the hydrogen bond, such as a hydroxyl group in the functional group. If the number of carbon atoms is 10 or less, the solubility in water can be ensured. Moreover, the functional group such as the hydroxyl group improves the water solubility.

When the polymer of the present invention is the polymer containing the repeating unit represented by the formula (1), a proportion of the repeating unit represented by the formula (1) is preferably 60% or more, further preferably 80% or more, and particularly preferably 90% or more of all the repeating units.

If the polymer contains 60% or more of the repeating unit represented by the formula (1), the polymer can provide preferable electrochemical stability and physical characteristics for the electrochemical element with, and slurry having satisfactory dispersibility can be prepared.

In the formula (1), a COOX moiety corresponds to the anionic unit. Accordingly, for example, when the polymer of the present invention is the polymer consisting of the repeating unit represented by the formula (1), X in the polymer satisfies a relationship in which a proportion: {(X being a metal ion)+(X being an aliphatic hydrocarbon group)}/{(X being a hydrogen ion)+(X being a metal ion)+(X being an aliphatic hydrocarbon group)} is 95% or less.

The polymer of the present invention is preferably a polymer composed of amino acid or a neutralized product of the amino acid in 50% or more of all the repeating units, further preferably a polymer composed of amino acid or a neutralized product of amino acid in 70% or more of all the repeating units, and still further preferably a polymer composed of amino acid or a neutralized product of amino acid in 90% or more of all the repeating units. The amino acid can be obtained as a natural product, and is preferable from a viewpoint of availability or environmental friendliness. As the amino acid, glutamic acid or aspartic acid is preferable.

The polymer of the present invention is a polymer containing a structure in which one or more amino acids selected from glutamic acid or a neutralized product of glutamic acid and aspartic acid or a neutralized product of aspartic acid are polymerized in an α-position, a β-position, or a γ-position, in preferably 50% or more, further preferably 70% or more, and sill further preferably 90% or more of all the repeating units.

The polymer composed of the amino acid or the neutralized product of amino acid described above contains the anionic unit and the nonionic unit in one repeating unit, and therefore solubility in water, dispersibility and stability to pH can be expected. The polymers described above are obtained by utilizing naturally occurring amino acid to have high environmental friendliness. The neutralized product is preferably a neutralized product of a metal ion, further preferably a neutralized product of an alkali metal ion or an alkaline earth metal ion, and still further preferably a neutralized product of a Li ion or a Na ion.

The polymer of the present invention is preferably poly-γ-glutamic acid or a neutralized product of poly-γ-glutamic acid, and further preferably an atactic polymer in which L-glutamic acid or a neutralized product of L-glutamic acid and D-glutamic acid or a neutralized product of D-glutamic acid coexist. The atactic polymer has low crystallinity and high flexibility, and therefore is hard to cause cracking upon being applied as the electrode, and a satisfactory electrode sheet can be established.

A weight-average molecular weight (Mw, polyethylene glycol (PEG) equivalent) of the polymer of the present invention is preferably 50,000 or more and 9,000,000 or less, further preferably 80,000 or more and 7,000,000 or less, and still further preferably 100,000 or more and 6,000,000 or less.

If the molecular weight of the polymer is 50,000 or more, the polymer becomes hard to be eluted into the electrolytic solution, and binding action by entanglement of molecular chains is obtained, and therefore the bindability can also be expected to be satisfactory. If the molecular weight of the polymer is 9,000,000 or less, solubility of the polymer into water is obtained, and an electrode composition having viscosity capable of coating can be prepared.

The weight-average molecular weight of the polymer can be measured by gel permeation chromatography. The weight-average molecular weight can be measured, for example, by using two columns of TSKgel GMPWXL made by Tosoh Corporation, 0.2 M NaNO₃ aqueous solution as a solvent, and RI-1530 made by JASCO Corporation as a refractive index (RI) detector and in terms of a PEG equivalent determined by drawing a 3rd order calibration curve by using TSKgel std PEO made by Tosoh Corporation and PEG made by Agilent Technologies, as standard samples. A sample concentration should be adjusted to about 0.3 mass % (hereinafter, described as mass %).

The polymer of the present invention can also be crosslinked and used upon being used as the binder. Crosslinking includes crosslinking caused by adding a polyvalent metal ion, crosslinking according to a condensation reaction by heating, chemical crosslinking caused by adding a material having a moiety reacting with a carboxylic acid moiety, such as carbodiimide, and electron beam crosslinking, but is not limited thereto.

The polymer of the present invention can be manufactured by performing polymerization by using a polymerizable monomer forming the anionic unit and a polymerizable monomer forming the nonionic unit, or a polymerizable monomer having both the anionic unit and the nonionic unit.

The degree of neutralization can be adjusted by adding a basic compound to a non-neutralized anion unit by calculating equivalence, or adding acid to a neutralized anionic unit. Because the salt after neutralization is unnecessary to be removed, such a material is preferably applied as the polymer of the present invention as prepared by manufacturing the polymer by using the polymerizable monomer forming the non-neutralized anionic unit and the polymerizable monomer forming the nonionic unit, or the polymerizable monomer having both the non-neutralized anionic unit and the nonionic unit, and neutralizing the polymer obtained.

A base such as sodium carbonate, sodium hydroxide, lithium carbonate and lithium hydroxide can be used for neutralizing the anionic unit without limitation.

Specific examples of the polymerizable monomer forming the anionic unit include itaconic acid, fumaric acid, maleic acid, 3-sulfopropyl acrylate and 2-(methacryloyloxy)ethyl phosphate. A homopolymer of the polymerizable monomers, a copolymer with any other polymerizable monomer, and an alkali-neutralized product of the polymerizable monomers can be used as a polymer-based dispersing agent and surfactant.

Specific examples of the polymerizable monomer forming the nonionic unit include a monomer having an aromatic ring, a monomer having a chain saturated hydrocarbon group, a monomer having a cyclic saturated hydrocarbon group, a monomer having a polyoxyalkylene structure, a monomer having a hydroxyl group and a nitrogen-containing monomer.

Specific examples of the monomer having the aromatic ring include styrene, α-methylstyrene and benzyl (meth)acrylate.

Specific examples of the monomer having the chain saturated hydrocarbon group include alkyl (meth)acrylate having 1 to 22 carbons, such as methyl (meth)acrylate, ethyl (meth)acrylate, propyl (meth)acrylate and butyl (meth)acrylate. Specific examples of alkyl (meth)acrylate having 1 to 22 carbons include preferably alkyl (meth)acrylate having 2 to 12 carbons, and further preferably alkyl group-containing acrylate having an alkyl group having 2 to 8 carbons or methacrylate corresponding thereto.

An alkyl group of the alkyl (meth)acrylate described above may be branched, and specific examples include isopropyl (meth)acrylate, isobutyl (meth)acrylate, tert-butyl (meth)acrylate, 2-ethylhexyl (meth)acrylate and 2-butylhexyl (meth)acrylate.

Moreover, specific examples of the monomer having the chain saturated hydrocarbon group include a fatty acid vinyl compound such as vinyl acetate, vinyl butyrate, vinyl propionate, vinyl hexanoate, vinyl caprylate, vinyl laurate, vinyl palmitate and vinyl stearate. Further, specific examples of the monomer having the chain saturated hydrocarbon group include an α-olefin compound such as 1-hexene, 1-octene, 1-decene, 1-dodecene, 1-tetradecene and 1-hexadecene.

Specific examples of the monomer having the cyclic saturated hydrocarbon group include isobornyl (meth)acrylate, dicyclopentanyl (meth)acrylate, cyclohexyl (meth)acrylate, trimethylcyclohexyl (meth)acrylate and 1-adamantyl (meth)acrylate.

Specific examples of the monomer having the polyoxyalkylene structure include monoacrylate or monomethacrylate having a hydroxyl group at a terminal and having a polyoxyalkylene chain, such as diethylene glycol mono(meth)acrylate, polyethylene glycol mono(meth)acrylate and polypropylene glycol mono(meth)acrylate; and a monoacrylate having an alkoxy group at a terminal and having a polyoxyalkylene chain or monomethacrylate corresponding thereto, such as methoxy ethylene glycol (meth)acrylate, methoxy diethylene glycol (meth)acrylate, methoxy polyethylene glycol (meth)acrylate and methoxy polypropylene glycol (meth)acrylate.

Moreover, specific examples of an alkyl vinyl ether compound, which is the monomer having the polyoxyalkylene structure, include butyl vinyl ether and ethyl vinyl ether. Further, a cyclic compound such as glycidyl (meth)acrylate and tetrahydrofurfuryl (meth)acrylate may be used.

Specific examples of the monomer having the hydroxyl group include 2-hydroxyethyl (meth)acrylate, 2-hydroxypropyl (meth)acrylate, 4-hydroxybutyl (meth)acrylate, glycerol mono (meth)acrylate, 4-hydroxystyrene, vinyl alcohol and allyl alcohol.

Moreover, specific examples of the monomer, which is a derivative of vinyl alcohol, include vinyl ester such as vinyl acetate, vinyl propionate and vinyl versatate. The hydroxyl group can be formed by copolymerizing the vinyl esters and saponifying the copolymer obtained with sodium hydroxide or the like.

Specific examples of the nitrogen-containing monomer include monoalkylol (meth)acrylamide such as N-vinyl-2-pyrrolidone, (meth)acrylamide, N-vinylacetamide, N-methylol (meth)acrylamide, N-methoxymethyl (meth)acrylamide; and N,N-di(methylol)acrylamide, N-methylol-N-methoxymethyl (meth)acrylamide and N,N-di(methoxymethyl)acrylamide.

Specific examples of any other monomer forming the nonionic unit include perfluoroalkylalkyl (meth)acrylates having a perfluoroalkyl group having 1 to 20 carbons, such as perfluoromethylmethyl (meth)acrylate, perfluoroethylmethyl (meth)acrylate, 2-perfluorobutylethyl (meth)acrylate and 2-perfluorohexylethyl (meth)acrylate; perfluoroalkyl group-containing vinyl monomer such as perfluoroalkyl and perfluoroalkylenes including perfluorobutylethylene, perfluorohexylethylene, perfluorooctylethylene and perfluorodecylethylene; and a silanol group-containing vinyl compound, such as vinyltricholorosilane, vinyltris(β-methoxyethoxy)silane, vinyltriethoxysilane and γ-(meth)acryloxypropyltrimethoxysilane; and a derivative thereof.

An ethynyl compound can also be used as the monomer forming the nonionic unit, and specific examples of the ethynyl compound include acetylene, ethynylbenzene, ethynyltoluene and 1-ethynyl-1-cyclohexanol.

The binder of the present invention contains the polymer of the present invention, and a content of the polymer is preferably 10 mass % or more, further preferably 30 mass % or more, and particularly preferably 50 mass % or more. If the content of the polymer is 10 mass % or more, satisfactory bindability of the binder can be expected.

The binder of the present invention may consist essentially of the polymer of the present invention, the solvent arbitrarily contained therein, and any other component arbitrarily contained therein. For example, 70 mass % or more, 80 mass % or more, or 90 mass % or more of the binder of the present invention may be the polymer of the present invention, the solvent arbitrarily contained therein, and any other component arbitrarily contained therein. Moreover, the binder of the present invention may consist of the polymer of the present invention, the solvent arbitrarily contained therein, and any other component arbitrarily contained therein. In this case, the binder of the present invention may contain inevitable impurities.

Here, a term “any other component” means an emulsion, a dispersing agent, any other water-soluble polymer, a pH adjuster or the like.

As a method for manufacturing the binder, the binder can be prepared by adding and mixing the polymer of the present invention, and the solvent arbitrarily contained therein and any other component arbitrarily contained therein (the emulsion, the dispersing agent, any other water-soluble polymer, the pH adjuster or the like).

Moreover, such materials may be added according to the order when the electrode composition described later is prepared. For example, the electrode composition can be prepared by mixing the active material, the conductive auxiliary agent and the polymer of the present invention, and then adding the solvent to the resulting mixture to form a homogeneous dispersion liquid, and adding any other component (the emulsion or the pH adjuster) thereto and mixing the resulting dispersion liquid.

The binder of the present invention ordinarily contains a solvent, and is preferably a binder containing water as the solvent. A content of water in the solvent is preferably as large as possible, and is preferable in the order of 10%, 30%, 50%, 70%, 80%, 90% and 100%, for example. More specifically, a case where the solvent in the binder is only water is most preferable.

Since the binder of the present invention is an aqueous binder containing a large amount of water, the environmental load can be minimized, and a solvent recovery cost can also be reduced.

Specific examples of the solvent other than water which may be contained in the binder include an alcohol-based solvent such as ethanol and 2-propanol, acetone, NMP, and ethylene glycol. However, the solvent other than water is not limited thereto.

The emulsion contained in the binder of the present invention is not particularly limited, and specific examples of the emulsion include a non-fluorine-based polymer such as a (meth)acrylic polymer, a nitrile-based polymer and a diene-based polymer; and a fluorine-based polymer (fluorine-containing polymer) such as PVDF and PTFE (polytetrafluoroethylene). The emulsion is preferably a material having excellent bindability between particles and flexibility (film flexibility). From the viewpoint described above, specific examples of the emulsion include a (meth)acrylic polymer, a nitrile-based polymer, and a (meth)acryl-modified fluorine-based polymer.

The dispersing agent contained in the binder of the present invention is not particularly limited, and various dispersing agents including an anionic, nonionic, or cationic surfactant, or a polymer dispersing agent such as a copolymer of styrene and maleic acid (including a half ester copolymer-ammonium salt) can be used.

When the binder contains the dispersing agent, the binder preferably contains the dispersing agent in 5 to 20 parts by mass based on 100 parts by mass of the conductive auxiliary agent described later. If a content of the dispersing agent is within such a range, the conductive auxiliary agent can be sufficiently formed into fine particles, and the dispersibility when the active material is mixed therein can be sufficiently ensured.

Specific examples of any other water-soluble polymer contained in the binder of the present invention include polyoxyalkylene, water-soluble cellulose, polyacrylic acid and a neutralized product thereof.

The pH adjuster contained in the binder is not particularly limited, and is preferably weak acid. The weak acid is preferably organic acid such as oxalic acid and acetic acid; oxo acid such as phosphoric acid, carbonic acid and boric acid; ester of the organic acid or the oxo acid; a partially neutralized product of the organic acid or the oxo acid; and polymer acid such as polyacrylic acid and polyvinyl phosphoric acid, and further preferably phosphoric acid, ester of phosphoric acid or a partially neutralized product of phosphoric acid. If the weak acids are used, pH is easily and appropriately adjusted, and risk of corroding the active material is also less. It should be noted that a term “partially neutralized product” herein means a product including a compound obtained by neutralizing phosphoric acid with lithium by only one of ionizable protons of phosphoric acid such as lithium dihydrogen phosphate, for example, for the partially neutralized product of phosphoric acid.

When the pH adjuster is strong acid, risk of corroding the active material or excessively reducing pH is caused.

When the binder contains the pH adjuster, pH of the electrode composition containing the binder can be adjusted within the range in which the current collector is not corroded.

When the binder contains the pH adjuster, a content of the pH adjuster is adjusted to be preferably 10 wt % or less, further preferably 5 wt % or less, and still further preferably 2 wt % or less, based on 100 wt % of the active material contained in an objective electrode composition.

The binder and the electrode composition preferably do not contain the pH adjuster, and as the pH adjuster is less, such a case is better.

Then, pH of the binder of the present invention is 1.5 or more, further 3.0 or more, and still further preferably 4.0 or more, for example. On the other hand, pH of the binder is preferably not more than 10.0.

Then, pH of the binder can be confirmed by measuring, at 25° C., a 1 mass % aqueous solution of the binder by using a glass electrode type pH meter TES-1380 (product name, made by CUSTOM Corporation).

With regard to the binder of the present invention, a current value per 1 mg of binder upon mixing the polymer contained in the binder and the conductive auxiliary agent described later at a mass ratio of 1:1, and being oxidized in the electrolytic solution under 4.8 V vs. Li⁺/Li is preferably 0.045 mA/mg or less, further preferably 0.03 mA/mg or less, and still further preferably 0.02 mA/mg or less. If an oxidation current of the binder at 4.8 V is 0.045 mA/mg or less, degradation in use for a long period of time can be suppressed, even if the binder is used in a material under a high voltage system, and degradation at a high temperature can be suppressed in an ordinary positive electrode composition (layered lithium complex oxide) of 4 V class.

The above-described current value can be measured by the method described in Examples.

The binder of the present invention can favorably cause dispersion of carbon particles, which are the conductive auxiliary agent, upon using water as the solvent. A conductive path can be allowed to uniformly exist by favorably dispersing the conductive auxiliary agent thereinto, resistance of the current collector with the active material is low, and satisfactory output characteristics are obtained.

Dispersibility of the conductive auxiliary agent can be measured by using a grind gauge, and in slurry formed by using water as the solvent, in which a solid content concentration is 10% at a weight ratio of 2:1 of the conductive auxiliary agent to the binder as described later, coarse particles having a particle size of 25 μm or less are preferably not observed, an upper limit of the particle size is further preferably 15 μm or less, and particularly preferably 10 μm or less. The particle size of the coarse particles measured by the grind gauge depends on the particle size of the conductive auxiliary agent to be used, and the particle size is smaller, such a case is better. A small size of the coarse particles means that the conductive auxiliary agent is dispersed without being aggregated.

The dispersibility of the conductive auxiliary agent can be measured according to the method described in Examples.

### Electrode Composition

The binder of the present invention can be preferably used as the binder for the electrode composition with which the electrode for the electrochemical element is formed. The binder of the present invention can be used in any of the positive electrode composition containing the positive electrode active material, and a negative electrode composition containing a negative electrode active material, and can be particularly preferably used in the positive electrode composition because of its high oxidation resistance.

The electrode composition containing the binder of the present invention (hereinafter, referred to as the electrode composition of the present invention in several cases) contains the active material and the conductive auxiliary agent in addition to the binder.

The conductive auxiliary agent is used for achieving high output of the secondary battery, and specific examples of the conductive auxiliary agent include conductive carbon.

Specific examples of the conductive carbon include carbon black such as Ketjen black and acetylene black; fibrous carbon; and graphite. Among the materials, Ketjen black or acetylene black is preferable. Ketjen black has a hollow shell structure to easily form a conductive network. Therefore, equivalent performance can be developed at about half amount of addition in comparison with the conventional carbon black. In acetylene black, impurities by-produced are significantly small by using a high-purity acetylene gas, and crystallites on the surface are developed, and therefore such acetylene black is preferable.

Carbon black, which is the conductive auxiliary agent, is preferably a material having an average particle size of 1 μm or less. When the electrode composition of the present invention is used and formed into the electrode, the electrode having excellent electric characteristics such as output characteristics can be formed by using the conductive auxiliary agent having the average particle size of 1 μm or less.

The average particle size of the conductive auxiliary agent is further preferably 0.01 to 0.8 μm, and still further preferably 0.03 to 0.5 μm. The average particle size of the conductive auxiliary agent can be measured by a dynamic light scattering particle size analyzer (for example, a refractive index of the conductive auxiliary agent is adjusted to 2.0).

If a carbon nanofiber or a carbon nanotube is used as fibrous carbon, which is the conductive auxiliary agent, it is preferable because the conductive path can be secured and therefore the output characteristics or cycle characteristics are improved.

Fibrous carbon preferably has a diameter of 0.8 nm or more and 500 nm or less, and a length of 1 μm or more and 100 μm or less. If the diameter is within the range, sufficient strength and dispersibility are obtained, and if the length is within the range, the conductive path by a fiber shape can be secured.

The positive electrode active material is preferably the active material capable of absorbing and desorbing a lithium ion. The positive electrode composition is formed into a preferable material as the positive electrode of the lithium-ion battery by using such a positive electrode active material.

Examples of the positive electrode active material include various oxides and sulfides, and specific examples include manganese dioxide (MnO₂), lithium manganese complex oxide (for example, LiMn₂O₄ or LiMnO₂), lithium nickel complex oxide (for example, LiNlO₂), lithium cobalt complex oxide (LiCoO₂), lithium nickel cobalt complex oxide (for example, LiNi₁₊ₓCoₓO₂), lithium-nickel-cobalt-aluminum complex oxide (LiNi_{0.8}Co_{0.15}Al_{0.05}O₂), lithium manganese cobalt complex oxide (for example, LiMnₓCo₁₋ₓO₂), lithium nickel cobalt manganese complex oxide (for example, LiNiₓMn_{y}Co_{1-x-y}O₂), a polyanion-based lithium compound (for example, LiFePO₄, LiCoPO₄F and Li₂MnSiO₄) and vanadium oxide (for example, V₂O₅). Moreover, specific examples of the positive electrode active material include an organic material such as a conductive polymer material and a disulfide-based polymer material. Specific examples of the positive electrode active material also include sulfur and a sulfur compound material such as lithium sulfide. With regard to a material having low conductivity, a composite is also preferably formed with a conductive material such as conductive carbon.

Among the materials, such a material is preferable as lithium manganese complex oxide (LiMn₂O₄), lithium nickel complex oxide (LiNiO₂), lithium cobalt complex oxide (LiCoO₂), lithium nickel cobalt complex oxide (LiNi_{0.8}Co_{0.2}O₂), lithium-nickel-cobalt-aluminum complex oxide (LiNi_{0.8}Co_{0.15}Al_{0.05}O₂), lithium manganese cobalt complex oxide (LiMnₓCo₁₋ₓO₂), lithium nickel cobalt manganese complex oxide (for example, LiNiₓMn_{y}Co_{1-x-y}O₂), Li-rich nickel-cobalt-manganese complex oxide (LiₓNi_{A}Co_{B}Mn_{C}O₂ solid solution), LiCoPO₄ and LiNi_{0.5}Mn_{1.5}O₄.

From a viewpoint of a battery voltage, the positive electrode active material is preferably Li complex oxide represented by LiMO₂, LiM₂O₄, Li₂MO₃ or LiMXO_{3 or 4}. Here, M is composed of one or more transition metal elements selected from Ni, Co, Mn, and Fe in 80% or more, but in addition to the transition metal, Al, Ga, Ge, Sn, Pb, Sb, Bi, Si, P, B or the like may be added thereto. X is composed of one or more elements selected from P, Si, and B in 80% or more.

Among the above-described positive electrode active materials, complex oxide of LiMO₂, LiM₂O₄ or Li₂MO₃ in which M is one or more of Ni, Co and Mn is preferable, and complex oxide of LiMO₂ in which M is one or more of Ni, Co and Mn is more preferable. Such Li complex oxide has larger electric capacity per volume (Ah/L) in comparison with a positive electrode material such as a conductive polymer, which is effective in improving energy density.

From a viewpoint of battery capacity, as the positive electrode active material, Li complex oxide represented by LiMO₂ is preferable. Here, M preferably contains Ni, further preferably contains Ni in 20% or more of M, and still further preferably contains Ni in 45% or more of M. If M contains Ni, the electric capacity per weight (Ah/kg) of the positive electrode active material increases in comparison with a case where M is Co and Mn, which is effective in improving the energy density.

When the positive electrode active material is Ni-containing layered lithium complex oxide, a rise of pH by an excessive Li salt or the like is observed in the electrode composition containing the positive electrode active material, and the characteristics inherent to the active material are not obtained by corrosion of the current collector (aluminum or the like) in several cases. On the other hand, when the binder of the present invention is used in the electrode composition, the carboxyl group moiety of the binder polymer suppresses the rise of pH, and corrosion of the current collector of Ni-containing layered lithium complex oxide can be prevented, and the characteristics inherent to the positive electrode active material can be obtained.

Moreover, the lithium complex oxide has risk of capacity degradation by elution of a metal ion and precipitation of the eluted metal ion in the negative electrode. However, the carboxyl group moiety of the polymer of the present invention captures an eluted metal ion. Thus, it can be expected to prevent capacity degradation due to the eluted metal ions reaching the negative electrode.

The positive electrode active material can also be coated with metal oxide, carbon or the like. Degradation when the positive electrode active material is brought into contact with water can be suppressed by coating the positive electrode active material with metal oxide or carbon, and oxidative decomposition of the binder or the electrolytic solution during charging can be suppressed.

The metal oxide used for coating the material is not particularly limited, but metal oxide such as Al₂O₃, ZrO₂, TiO₂, SiO₂ and AlPO₄, or a compound represented by LiαMβOγ containing Li may be used. It should be noted that, in LiαMβOγ, M is one or more metal elements selected from the group consisting of Al, Ti, Cr, Mn, Fe, Co, Ni, Cu, Zr, Nb, Mo, Ag, Ta, W and Ir, in which expressions: 0≤α≤6, 1≤β≤5, and 0<γ≤12 hold.

In the positive electrode composition containing the positive electrode active material, the conductive auxiliary agent and the binder of the present invention, a content proportion (weight ratio) of the polymer of the present invention, the positive electrode active material, the conductive auxiliary agent, the emulsion, and any other component other than the components in a solid content of the positive electrode composition preferably satisfies a ratio: (polymer of the present invention):(positive electrode active material):(conductive auxiliary agent):(emulsion):(any other component)=0.2 to 15:70 to 98:2 to 20:0 to 10:0 to 5.

In such a content proportion, the output characteristics and the electric characteristics when the electrode formed of the positive electrode composition is used as the positive electrode of the battery can be made excellent. The content proportion is further preferably 0.5 to 12:80 to 97:1 to 10:0 to 6:0 to 2. The content proportion is still further preferably 1.0 to 8:85 to 97:1.5 to 8:0 to 4:0 to 1.5. It should be noted that any other component herein means a component other than the polymer of the invention, the positive electrode active material, the conductive auxiliary agent and the emulsion, and includes the dispersing agent, and the water-soluble polymer other than the polymer of the present invention, or the like.

The positive electrode composition containing the binder of the present invention ensures dispersion stability of the positive electrode active material, the conductive auxiliary agent or the like, and can be further formed into a material excellent in an ability of forming a coating film and adhesion with a substrate. Then, the positive electrode formed of such a positive electrode composition can develop sufficient performance as the positive electrode for the secondary battery.

When the positive electrode composition is a material containing the binder of the present invention, the positive electrode active material, the conductive auxiliary agent, the emulsion and water, a method for manufacturing the positive electrode aqueous composition is not particularly limited, as long as the positive electrode active material and the conductive auxiliary agent are uniformly dispersed thereinto, and the positive electrode composition can be manufactured by using a beads mill, a ball mill, an agitation type mixer, or the like.

As the negative electrode active material, a carbon material such as graphite, natural graphite, and artificial graphite; complex metal oxide such as a polyacene-based conductive polymer and lithium titanate; or a material ordinarily used in the lithium-ion secondary battery, such as silicon, silicon alloy, silicon complex oxide, and lithium alloy can be used. Among the materials, a carbon material, silicon, silicon alloy, or silicon complex oxide is preferable. The materials may be formed into the composite and used or mixed and used, when necessary.

Among the above-described negative electrode active materials, for the negative electrode active material having low initial charge and discharge efficiency, such as the silicon complex oxide, lithium may be incorporated thereinto in advance (pre-doping). As a pre-doping method, a publicly-known method can be used, in which a method of allowing the material to react with a lithium metal in a solution, or the like can be adopted.

The above-described negative electrode active material can be dispersed into water by suppressing reaction by applying surface modification such as carbon coat onto a surface. However, when the carbon coat or the like is not uniformly performed, alkali content such as lithium contained in the active material reacts with water to convert the electrode composition into a basic material, resulting in causing risk of corroding the current collector or the active material, or gas generation or gelling of the composition.

In the negative electrode composition containing the negative electrode active material, the conductive auxiliary agent and the binder of the present invention, a content proportion (weight ratio) of the polymer of the present invention, the negative electrode active material, the conductive auxiliary agent, the emulsion and any other component in a solid content of the negative electrode composition is preferably 0.3 to 25:75 to 99:0 to 10:0 to 9:0 to 5. In such a content proportion, the output characteristics and the electric characteristics can be made excellent when the electrode formed of the negative electrode composition is used as the negative electrode of the battery. The content proportion is further preferably 0.5 to 20:80 to 98.7:0 to 5:0 to 3:0 to 3. The content proportion is still further preferably 1.0 to 18:82 to 98:0 to 4:0 to 2.5:0 to 1.5. It should be noted that any other component herein means to a component other than the binder, such as the negative electrode active material, the conductive auxiliary agent, the polymer of the present invention and the emulsion, and includes the dispersing agent, a thickening agent or the like.

The negative electrode composition containing the binder of the present invention ensures dispersion stability of the negative electrode active material, and further can be made excellent in the ability of forming the coating film and the adhesion with the substrate. Then, the negative electrode formed of such a negative electrode composition can develop sufficient performance as the negative electrode for the secondary battery.

When the negative electrode composition is a material containing the binder of the present invention, the negative electrode active material, the conductive auxiliary agent, the emulsion and water, a method for manufacturing the negative electrode aqueous composition is not particularly limited, as long as the negative electrode active material and the conductive auxiliary agent are uniformly dispersed thereinto, and the negative electrode aqueous composition can be manufactured by using the beads mill, the ball mill, the agitation type mixer, or the like.

The electrode composition of the present invention may consist essentially of the binder of the present invention, the active material and the conductive auxiliary agent, and further may contain the solvent. For example, 70 wt % or more, 80 wt % or more or 90 wt % or more of the electrode composition of the present invention may be the binder of the present invention, the active material, the conductive auxiliary agent and the solvent. Moreover, the electrode composition of the present invention may consist of the binder of the present invention, the active material and the conductive auxiliary agent and the solvent. In this case, the electrode composition may contain the inevitable impurities.

It should be noted that, as the solvent contained in the electrode composition, the solvent that can be used for the binder can be used, and the solvent may be the same with or different from the solvent contained in the binder.

As a method for manufacturing the electrode composition, the electrode composition can be prepared by adding and mixing the binder of the present invention, the active material, the conductive auxiliary agent and other arbitrary component (the emulsion, the dispersing agent or the like) in batch.

Moreover, the electrode composition may be prepared by adding and mixing the binder of the present invention, the active material, the conductive auxiliary agent and any other arbitrary component (the emulsion, the dispersing agent or the like) according to the order. For example, the electrode composition can be prepared by mixing the active material, the conductive auxiliary agent and the poly-γ-glutamic acid compound of the present invention, and then adding the solvent thereto, and mixing the resulting mixture into a homogeneous dispersion liquid, and adding any other component (the emulsion or the pH adjuster) to the resulting dispersion liquid and mixing the resulting mixture.

It should be noted that the pH adjuster may be contained in the binder in advance, or may be added during preparation of the electrode composition.

A layered active material having a large Ni content cannot be sufficiently neutralized only with the binder in several cases, and therefore acid may be added thereto as the pH adjuster. As the pH adjuster contained in the electrode composition, the same pH adjuster with the pH adjuster contained in the binder can be used, and pH adjuster is preferably weak acid such as phosphoric acid. Existence of the salt of the weak acid such as the phosphoric acid on a surface of the active material causes neutralization of acid according to an acid-base exchange reaction when hydrofluoric acid is generated, and suppression of corrosion of the active material can be expected.

The electrode composition of the present invention can be formed into the electrode by applying the electrode composition onto the current collector, and then drying the resulting material.

More specifically, when the electrode composition is the positive electrode composition containing the positive electrode active material, the positive electrode composition can be formed into the electrode by applying the positive electrode composition onto a positive electrode current collector, and then drying the resulting material. When the electrode composition is the negative electrode composition containing the negative electrode active material, the negative electrode composition can be formed into the negative electrode by applying the negative electrode composition onto a negative electrode current collector, and then drying the resulting material.

The positive electrode current collector is not particularly limited, as long as a material which has electron conductivity and may conduct current to the positive electrode material held therein is applied thereto. As the positive electrode current collector, for example, the conductive material such as C, Ti, Cr, Mo, Ru, Rh, Ta, W, Os, Ir, Pt, Au, and Al; or an alloy containing two or more kinds of the conductive materials (stainless steel, for example) can be used.

From viewpoints of having high electrical conductivity, and stability in the electrolytic solution, and satisfactory resistance to oxidation, C, Al, stainless steel, or the like is preferable as the positive electrode current collector, and from a viewpoint of a material cost, Al is further preferable.

The negative electrode current collector can be used without particular limitation, as long as the conductive material is applied thereto, and an electrochemically stable material is preferably used during a battery reaction such as copper, stainless steel, nickel or the like can be used, for example.

A shape of the current collector is not particularly limited, and a foil-shaped substrate, a three-dimensional substrate, or the like can be used. Among the materials, if the three-dimensional substrate (a foamed metal, a mesh, a woven fabric, a nonwoven fabric, an expanded material, or the like) is used, even with such an electrode composition containing the binder as lacking adhesion with the current collector, the electrode having high capacity density is obtained, and high rate charge and discharge characteristics are also improved.

When the current collector is foil-shaped, high capacity can be achieved by preforming a primer layer on a surface of the current collector. The primer layer preferably has satisfactory adhesion between an active material layer and the current collector, and electrical conductivity. For example, the primer layer can be formed by applying a binder prepared by mixing a carbon-based conductive auxiliary agent therewith at a thickness of 0.1 μm to 50 μm on the current collector.

The conductive auxiliary agent for the primer layer is preferably carbon powder. The metal-based conductive auxiliary agent can increase the capacity density, but the input and output characteristics may deteriorate. On the other hand, the carbon-based conductive auxiliary agent can improve the input and output characteristics.

Specific examples of the carbon-based conductive auxiliary agent include Ketjen black, acetylene black, a vapor grown carbon fiber, graphite, graphene, and a carbon tube, and may be used alone in one kind or in combination of two or more kinds. Among the materials, from viewpoints of conductivity and cost, Ketjen black or acetylene black is preferable.

The binder for the primer layer is not particularly limited, as long as the material can bind the carbon-based conductive auxiliary agent. However, if the primer layer is formed by using the aqueous binder such as PVA, CMC, and sodium alginate in addition to the binder of the present invention, the primer layer is dissolved therein upon forming the active material layer to have a risk according to which an effect is not significantly produced. Therefore, the primer layer should be crosslinked in advance upon using such an aqueous binder. Specific examples of a crosslinking material include a zirconium compound, a boron compound, and a titanium compound, and upon forming slurry for the primer layer, such a material should be added in 0.1 to 20 mass % based on the amount of binder.

The primer layer can not only increase the capacity density of a foil-shaped current collector by using an aqueous binder, but also reduce polarization and improve high rate charge and discharge characteristics even when charging and discharging is performed at a high current.

It should be noted that the primer layer is effective not only in the foil-shaped current collector, but an effect similar thereto is obtained also in the three-dimensional substrate.

### Secondary Battery

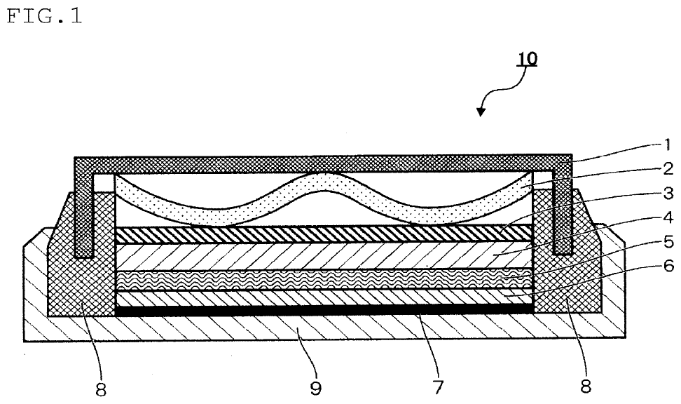

FIG. 1 is a schematic cross-sectional view showing one embodiment when a positive electrode composition of the present invention is applied as a positive electrode of a lithium-ion secondary battery.

In FIG. 1, a lithium-ion secondary battery 10 is formed by laminating a positive electrode current collector 7, a positive electrode 6, a separator and an electrolytic solution 5, a lithium metal 4 (negative electrode), and a SUS spacer 3 in this order on a positive electrode can 9, in which the laminate is fixed with gaskets 8 on both sides in a lamination direction, and with a negative electrode can 1 through a wave washer 2 in the lamination direction.

As the electrolytic solution in the secondary battery, a non-aqueous electrolytic solution, which is a solution prepared by dissolving an electrolyte into an organic solvent, can be used.

Specific examples of the organic solvent include carbonates such as propylene carbonate, ethylene carbonate, butylene carbonate, dimethyl carbonate, diethyl carbonate and methylethyl carbonate; lactons such as γ-butyrolactone; ethers such as trimethoxymethane, 1,2-dimethoxyethane, diethyl ether, 2-ethoxyethane, tetrahydrofuran and 2-methyltetrahydrofuran; sulfoxides such as dimethyl sulfoxide; oxolanes such as 1,3-dioxolane and 4-methyl-1,3-dioxolane; nitrogen-containing compounds such as acetonitrile, nitromethane and NMP; esters such as methyl formate, methyl acetate, butyl acetate, methyl propionate, ethyl propionate and phosphotriester; glymes such as diglyme, triglyme and tetraglyme; ketones such as acetone, diethyl ketone, methyl ethyl ketone and methyl isobutyl ketone; sulfones such as sulfolane; oxazolidinones such as 3-methyl-2-oxazolidinone; and sultones such as 1,3-propanesultone, 4-butanesultone and naphthasultone. The organic solvents may be used alone in one kind or in combination of two or more kinds.

Specific examples of the electrolyte include LiClO₄, LiBF₄, LiI, LiPF₆, LiCF₃SO₃, LiCF₃CO₂, LiAsF₆, LiSbF₆, LiAlCl₄, LiCl, LiBr, LiB(C₂H₅)₄, LiCH₃SO₃, LiC₄F₉SO₃, Li(CF₃SO₂)₂N and Li[(CO₂)₂]₂B.

As the non-aqueous electrolytic solution, a solution prepared by dissolving LiPF₆ into carbonates is preferable, and the solution is particularly preferable as the electrolytic solution for the lithium-ion secondary battery.

As the separator for preventing short-circuit of current caused by contact between both electrodes of the positive electrode and the negative electrode, or the like, a material capable of reliably preventing the contact between both the electrodes, and capable of passing the electrolytic solution therethrough or containing the electrolytic solution therein should be used. For example, a nonwoven fabric made of a synthetic resin of polytetrafluoroethylene, polypropylene, polyethylene or the like, a glass filter, a porous ceramic film, a porous thin film, or the like can be used.

In order to provide the separator with a function such as heat resistance, the separator may be coated with the composition (application liquid) containing the binder of the present invention.

The heat resistance of the separator can be improved by coating, on the separator, a material obtained by mixing, in addition to the binder of the present invention, ceramic particles of silica, titanium oxide, aluminum oxide, zirconium oxide, magnesium oxide, niobium oxide, barium oxide or the like.

The metal ion derived from the positive electrode active material, eluted into the electrolytic solution, can be expected to be captured by coating the composition containing the binder of the present invention on the separator to suppress the metal ion from precipitating on the negative electrode or from functioning as a catalyst to excessively forming SEI (solid electrolyte interface).

As a separator substrate in the above-described coat, the material described above can be used without limitation, and a porous thin film is preferable, and a polyolefin porous film prepared according to a wet process or a dry process can be preferably used.

The above-described composition can be coated on the positive electrode or the negative electrode and used as a protective film. An improvement in the cycle characteristics of the battery can be expected by forming such a protective film on the positive electrode or the negative electrode.

The secondary battery can be manufactured, for example, by putting the negative electrode, the separator into which the electrolyte is impregnated, and the positive electrode in an exterior body and sealing the resulting material. A publicly-known method such as crimping and laminate sealing may be used as a sealing method.

### EXAMPLES

### Example 1-1

### Preparation of Binder A1 (Neutralized Sodium Polyglutamate)

To 3.01 g of poly-γ-glutamic acid (made by Wako Pure Chemical Industries, Ltd., for biochemistry, average molecular weight: 200,000 to 500,000), 10.4 g of distilled water was added, and dispersed to prepare a poly-γ-glutamic acid dispersion liquid.

In 5.82 g of distilled water, 0.617 g of sodium carbonate (made by Wako Pure Chemical Industries, Ltd., guaranteed reagent) was completely dissolved, the resulting aqueous solution of sodium carbonate was added to the poly-γ-glutamic acid dispersion liquid, and the resulting mixture was stirred until a homogeneous solution was formed to prepare a binder A1. A solid content concentration of the binder A1 prepared, determined from a theoretical yield, when all of carbon dioxide gas was considered to be eliminated, was 16.7 mass %.

When elemental analysis was performed on the binder A1 obtained, by using a CHN corder method and ICP atomic emission spectroscopy, a material amount ratio was: C:H:N:Na=40.7:5.4: 9.4:8.0. When the binder A1 was considered to be formed only of a repeating unit by neglecting a carboxyl group at a polymer terminal of poly-γ-glutamic acid, a degree of neutralization of the carboxyl group was found to be 51% from the ratio of N to Na.

Moreover, as a result of performing molecular weight measurement on the binder A1 obtained, according to GPC, a molecular weight of the polymer in the binder A1 was: Mw=107,000 (PEG equivalent).

It should be noted that pH of a 1 mass % aqueous solution of the binder A1 was 4.30. As pH of the binder A1, a 1 mass % aqueous solution of the binder A1 was separately prepared, and a value at 25° C. was determined by using a glass electrode type pH meter TES-1380 (made by CUSTOM Corporation).

### Example 1-2

### Preparation of Binder B1 (Neutralized Sodium Polyglutamate (High Molecular Weight))

To 3.00 g of poly-γ-glutamic acid (made by Wako Pure Chemical Industries, Ltd., for biochemistry, average molecular weight: 1,500,000 to 2,500,000), 10.4 g of distilled water was added, and dispersed to prepare a poly-γ-glutamic acid dispersion liquid.

In 5.86 g of distilled water, 0.621 g of sodium carbonate (made by Wako Pure Chemical Industries, Ltd., guaranteed reagent) was completely dissolved, the resulting aqueous solution of sodium carbonate was added to the poly-γ-glutamic acid dispersion liquid, and the resulting mixture was stirred until a homogeneous solution was formed to prepare a binder B1. A solid content concentration of the binder B1 prepared, determined from a theoretical yield, when all of carbon dioxide gas was considered to be eliminated, was 16.6 mass %.

As a result of performing elemental analysis and molecular weight measurement on the binder B1 obtained, in the same manner as in Example 1-1, a degree of neutralization of a carboxyl group of a polymer in the binder B1 was 54%, and a molecular weight of the polymer in the binder B1 was: Mw=146,000 (PEG equivalent).

It should be noted that pH of a 1 mass % aqueous solution of the binder B1 was 4.28. As pH of the binder B1, a 1 mass % aqueous solution of the binder B1 was separately prepared, and a value at 25° C. was determined by using a glass electrode type pH meter TES-1380 (made by CUSTOM Corporation).

### Example 1-3

### Preparation of Binder A2 (Neutralized Sodium Polyglutamate (High Molecular Weight))

To 5.01 g of poly-γ-glutamic acid (made by Wako Pure Chemical Industries, Ltd., for biochemistry, average molecular weight: 200,000 to 500,000), 15.5 g of distilled water was added, and dispersed to prepare a poly-γ-glutamic acid dispersion liquid.

In 9.71 g of distilled water, 1.03 g of sodium carbonate (made by Wako Pure Chemical Industries, Ltd., guaranteed reagent) was completely dissolved, the resulting aqueous solution of carbonate sodium was added to the poly-γ-glutamic acid dispersion liquid, and the resulting mixture was stirred until a homogeneous solution was formed to prepare a binder A2. A solid content concentration determined from a theoretical yield when all of carbon dioxide gas was considered to be eliminated was 17.6 mass %.

When elemental analysis was performed on the binder A2 obtained, by using a CHN corder method and ICP atomic emission spectroscopy, a material amount ratio was: C:H:N:Na=40.7:5.4:9.4:8.0. When the binder A2 was considered to be formed only of a repeating unit by neglecting a carboxyl group at a polymer terminal of poly-γ-glutamic acid, a degree of neutralization of the carboxyl group was found to be 51% from the ratio of N to Na.

Moreover, as a result of performing molecular weight measurement on the binder A2 obtained, according to GPC, a molecular weight of the polymer in the binder A2 was: Mw=107,000 (PEG equivalent).

### Example 1-4

### Preparation of Binder B2 (Neutralized Sodium Polyglutamate (High Molecular Weight))

To 5.01 g of poly-γ-glutamic acid (made by Wako Pure Chemical Industries, Ltd., for biochemistry, average molecular weight: 1,500,000 to 2,500,000), 15.9 g of distilled water was added, and dispersed to prepare a poly-γ-glutamic acid dispersion liquid.

In 9.68 g of distilled water, 1.02 g of sodium carbonate (made by Wako Pure Chemical Industries, Ltd., guaranteed reagent) was completely dissolved, the resulting aqueous solution of sodium carbonate was added to the poly-γ-glutamic acid dispersion liquid, and the resulting mixture was stirred until a homogeneous solution was formed to prepare a binder B2. A solid content concentration determined from a theoretical yield when all of carbon dioxide gas was eliminated was 17.4 mass %.

As a result of performing elemental analysis and molecular weight measurement on the binder B2 obtained, in the same manner as in Example 1-3, a degree of neutralization of a carboxyl group of a polymer in the binder B2 was 54%, and a molecular weight of the polymer in the binder B2 was: Mw=146,000 (PEG equivalent).

### Comparative Example 1-1

### Preparation of Binder C (Aqueous Solution of Polyacrylic Acid)

To 3.02 g of polyacrylic acid (made by Wako Pure Chemical Industries, Ltd., average molecular weight: 250,000), 12.0 g of distilled water was added, and completely dissolved to prepare a binder C being an aqueous solution having a solid content concentration of 20.0 mass %.

It should be noted that pH of a 1 mass % aqueous solution of the binder C was 2.59. As pH of the binder C, a 1 mass % aqueous solution of the binder C was separately prepared, and a value at 25° C. was determined by using a glass electrode type pH meter TES-1380 (made by CUSTOM Corporation).

### Comparative Example 1-2

### Preparation of Binder D (Aqueous Solution of Polyacrylic Acid)

PVDF (Mw=280,000, homopolymer of vinylidene fluoride) was completely dissolved in N-methylpyrrolidone (NMP) to be 12 mass % in a solid content concentration to prepare a binder D.

### Example 2-1

To a binder A2, acetylene black (made by Denka Company Limited, HS-100) and distilled water were added and mixed so as to satisfy a ratio: acetylene black:a solid content of the binder A2=1:1 (weight ratio) to obtain slurry. Hereinafter, unless otherwise specified, a planetary centrifugal mixer (THINKY MIXER) (AWATORIRENTARO) (ARE-310, made by THINKY Corporation) was used upon mixing the materials.

The slurry obtained was applied onto aluminum foil and dried at 80° C., and punched into a sheet having a diameter of 13 mm, and then dried in vacuum at 150° C. for 5 hours by further using a glass tube oven (GTO-200, made by Sibata Scientific Technology Ltd.) and an oil pump (G20D, made by ULVAC Kiko, Inc.) having an ultimate pressure of 1.3 Pa, and the resulting material was taken as a working electrode.

In an Ar-filled glove box in which an oxygen concentration was controlled to be 10 ppm or less and a moisture concentration was controlled to be 5 ppm or less, a gasket was fitted to a positive electrode can of a coin cell (Coin Cell 2032, made by Hohsen Corporation), a positive electrode being the working electrode manufactured and a separator were laminated in this order, and an electrolytic solution was added thereto. Further, a negative electrode, a SUS spacer, a wave washer, and a negative electrode can were stacked, and the resulting material was sealed with a coil cell crimper (made by Hohsen Corporation) to prepare a coin cell. A schematic cross-sectional view of the coin cell obtained is shown in FIG. 1.

It should be noted that each component of the coin cell is as described below. Each component of coin cell

Positive electrode: a sheet having a diameter of 13 mm manufactured as described above

Separator: a glass separator having a diameter of 16 mm (made by Advantech Toyo Co., Ltd. GA-100)

Negative electrode (counter electrode combined with reference electrode): Li foil having a diameter of 15 mm

Electrolytic solution: 1 mol/L LiPF₆ EC/DEC=3/7 (made by Kishida Chemical Co., Ltd.)

The coin cell manufactured was evaluated by measuring a current value at 4.8 V (based on lithium) under the following conditions and normalizing the current value to a current value per 1 mg of a binder amount on the electrode. The results are shown in Table 1.

### Measurement Conditions:

Measuring instrument: made by Hokuto Denko Corporation, PS08

Starting potential: spontaneous potential

End potential: 5V vs. Li+/Li

Sweep speed: 1 mV/sec

Measurement temperature: 25±10° C.

### Example 2-2

To a binder B2, acetylene black (made by Denka Company Limited, HS-100) and distilled water were added and mixed so as to satisfy a ratio: acetylene black:the binder B2=1:1 (weight ratio) to obtain slurry.

A coin cell was manufactured by using the slurry obtained and evaluated in the same manner as in Example 2-1. The results are shown in Table 1.

### Comparative Example 2-1

Slurry was prepared, and a coin cell was manufactured and evaluated in the same manner as in Example 2-1 except that the binder C was used in place of the binder A2. The results are shown in Table 1.

### Comparative Example 2-2

Slurry was prepared, and a coin cell was manufactured and evaluated in the same manner as in Example 2-1 except that the binder D was used in place of the binder A2 and NMP was used in place of distilled water, respectively. The results are shown in Table 1.

TABLE 1

| | | Current value |
|---|---|---|
| | Binder | [mA/mg] |
| Example 2-1 | Binder A2 | 0.018 |
| Example 2-2 | Binder B2 | 0.027 |
| Comparative Example 2-1 | Binder C | 0.006 |
| Comparative Example 2-2 | Binder D | 0.05 |

Table 1 shows that a current value is lower in the binder A2 and the binder B2 used in Examples 2-1 and 2-2 than in the binder D used in Comparative Example 2-2, and therefore it is found that the binder A2 and the binder B2 are electrically stable even during application of voltage as high as 4.8 V (based on lithium). As a result, it is found that the binder A2 and the binder B2 are better in durability than the binder D, and the binder for the positive electrode of a secondary battery to be able to withstand repeating charge and discharge.

### Example 3-1

### Evaluation of Dispersibility

To a binder A1, acetylene black (made by Denka Company Limited, HS-100) and distilled water were added and mixed so as to satisfy a ratio: acetylene black:a solid content in the binder A1=2:1 (weight ratio) to obtain slurry. Dispersibility was evaluated on the slurry prepared, as described below.

The slurry obtained was kneaded at 2000 rpm for 1 minute and defoamed at 2200 rpm for 1 minute, and then distilled water was further added thereto to adjust a solid content concentration to 9 to 10 mass %, and the resulting slurry was again kneaded at 2000 rpm for 5 minutes and defoamed at 2200 rpm for 1 minute, and dispersed. Then, presence or absence of coarse particles was confirmed by using a grinding gauge (made by Yasuda Seiki Seisakusho, Ltd., No 547, 25 μm) of 25 μm within 30 minutes. The presence or absence of the coarse particles can be measured in accordance with JIS K5600-2-5. As a result, no coarse particles were observed at all in the slurry in the range to 2.5 μm or less.

### Example 3-2

### Evaluation of Dispersibility

Slurry was prepared, and dispersibility was evaluated in the same manner as in Example 3-1 except that the binder B1 was used in place of the binder A1 As a result, no coarse particles were observed at all in the slurry in the range to 2.5 μm or less.

### Comparative Example 3-1

### Evaluation of Dispersibility

Slurry was prepared, and dispersibility was evaluated in the same manner as in Example 3-1 except that the binder C was used in place of the binder A1. As a result, coarse particles were observed in the slurry in the whole region from 25 μm.

### Example 4-1

To a binder A2 (0.318 g), LiNi_{0.5}Co_{0.2}Mn_{0.3}O₂ (2.79 g) and acetylene black HS-100 (made by Denka Company Limited) (0.151 g) were added, and the resulting material was taken as a mixed dispersion liquid. Water (1.02 g) was further added thereto to obtain a positive electrode composition (1).

The positive electrode composition (1) obtained was applied onto 20 μm-thick Al foil by using Micrometer Adjustable Film Applicator (SA-204, made by Tester Sangyo Co., Ltd.) and Auto Film Applicator (PI-1210, made by Tester Sangyo Co., Ltd.), and the resulting material was dried at 80° C. for 10 minutes. On the occasion, a phenomenon in which pH rose by remaining alkali of the active material to cause corrosion of the Al foil to generate hydrogen was not observed.

Then, the Al foil on which the positive electrode composition was applied was pressed at room temperature to prepare an electrode having a target basis weight of 1 mAh/cm² and porosity of 35%. The electrode obtained was punched into a sheet having a diameter of 13 mm, and dried in vacuum at 150° C. for 5 hours by using a glass tube oven (GTO-200, made by Sibata Scientific Technology Ltd.) and an oil pump (G20D, made by ULVAC Kiko, Inc.) having an ultimate pressure of 1.3 Pa to obtain a positive electrode.

In an Ar-filled glove box in which an oxygen concentration was controlled to be 10 ppm or less and a moisture concentration was controlled to be 5 ppm or less, a gasket was fitted to a positive electrode can of a coin cell (Coin Cell 2032, made by Hohsen Corporation), a positive electrode manufactured and a separator were laminated in this order, and an electrolytic solution was added thereto. Further, a negative electrode, a SUS spacer, a wave washer, and a negative electrode can were stacked, and the resulting material was sealed with a coil cell crimper (made by Hohsen Corporation) to prepare a coin cell. A schematic cross-sectional view of the coin cell obtained is shown in FIG. 1.

It should be noted that each component of the coin cell is as described below.

### Each Component of Coin Cell

Positive electrode: a sheet having a diameter of 13 mm prepared as described above

Separator: a glass separator having a diameter of 16 mm (made by Advantech Toyo Co., Ltd. GA-100)

Negative electrode (counter electrode combined with reference electrode): Li foil having a diameter of 15 mm

Electrolytic solution: 1 mol/L LiPF₆ EC/DEC=3/7 (made by Kishida Chemical Co., Ltd.)

Discharge capacity being charge and discharge characteristics of the coin cell obtained was evaluated under the following measurement conditions. The results are shown in Table 2. Irreversible capacity of initial charge and discharge was large under the following conditions in the discharge capacity evaluated, and therefore second cycle discharge capacity was adopted. As the rate characteristics, a capacity retention ratio (%) in 5 C was shown by presuming discharge capacity in 0.1 C as 100%.

It should be noted that battery capacity was calculated on the presumption of 160 mAh per 1 g of LiNi_{0.5}Co_{0.2}Mn_{0.3}O₂, and 1 C (a current value completely discharged in one hour) was calculated based on the capacity.

### Measurement Conditions:

Charge and discharge measuring device: BTS-2004 (made by NAGANO & Co., Ltd.)

Temperature: 30±5° C.

Initial Charge and Discharge

Charge conditions: 0.1 C-CC⋅CV

Charge end conditions: voltage: 4.3 V and current value: 0.02 C or less

Discharge conditions: 0.1 C-CC

Discharge end conditions: voltage: 2.0 V

Evaluation of Rate Characteristics

Charge conditions: 0.1 C-CC⋅CV

Charge end conditions: voltage: 4.3 V and current value: 0.02 C or less

Discharge conditions: 0.5 C-CC

Discharge end conditions: voltage: 2.0 V

Charge conditions: 0.1 C-CC⋅CV

Charge end conditions: voltage: 4.3 V and current value: 0.02 C or less

Discharge conditions: 1 C-CC

Discharge end conditions: voltage: 2.0 V

Charge conditions: 0.1 C-CC-CV

Charge end conditions: voltage: 4.3 V and current value: 0.02 C or less

Discharge conditions: 3 C-CC

Discharge end conditions: voltage: 2.0 V

Charge conditions: 0.1 C-CC-CV

Charge end conditions: voltage: 4.3 V and current value: 0.02 C or less

Discharge conditions: 5 C-CC

Discharge end conditions: voltage: 2.0 V

The following evaluation was also performed on the positive electrode composition obtained. The results are shown in Table 2.

### Coating Film Uniformity

The coating film obtained upon applying the positive electrode composition onto Al foil was visually confirmed. A case where lumps, corrosion of aluminum, or the like was unable to be confirmed on the Al foil was evaluated as “good” by deeming such a case as formation of a uniform coating film.

In Examples 4-1 and 4-2, a uniform and smooth coating film was formed in the same manner as in Comparative Example 4-2 in which NMP was used as the solvent, but in Comparative Example 4-1, the lumps caused by aggregates were wholly observed.

### Bindability

On electrode foil (20 mm×90 mm) before pressing as obtained by applying the above-described positive electrode on the Al foil and drying the resulting material, a cellophane tape (CT-15, made by Nichiban Co., Ltd.) was pasted thereon to be smoothened with a finger ball. Then, the cellophane tape was peeled off at 180° at a rate of 50 mm/min, and two sheets of electrodes each having a diameter of 13 mm were punched before and after being peeled off, respectively, and a retention rate of an electrode laminate on the Al current collector was calculated. It should be noted that the retention rate is preferably 50% or more, further preferably 70% or more, and particularly preferably 90% or more, on average. In both Example 4-1 and Example 4-2 described later, a retention rate of 50% or more was achieved, and an improvement of a battery yield or a satisfactory cycle life can be expected by preventing dusting during electrode processing or the like. On the other hand, in Comparative Example 4-2 described later, the retention rate was significantly lower than 50% to have risk of leading to reduction of the battery yield or the cycle life.

### Example 4-2

To a binder B2 (0.318 g), LiNi_{0.5}Co_{0.2}Mn_{0.3}O₂ (2.79 g) and acetylene black HS-100 (made by Denka Company Limited) (0.150 g) were added, and the resulting material was taken as a mixed dispersion liquid. Water (1.06 g) was further added thereto and mixed to obtain a positive electrode composition (2).

An electrode and a coin cell were manufactured and evaluated in the same manner as in Example 4-1 except that the positive electrode composition (2) was used in place of the positive electrode composition (1). The results are shown in Table 2.

### Comparative Example 4-1

To a binder C (0.303 g), LiNi_{0.5}Co_{0.2}Mn_{0.3}O₂ (2.79 g) and acetylene black HS-100 (0.151 g) were added, and the resulting material was taken as a mixed dispersion liquid. Water (1.43 g) was further added thereto and mixed to obtain a positive electrode composition (3).

An electrode and a coin cell were manufactured and evaluated in the same manner as in Example 4-1 except that the positive electrode composition (3) was used in place of the positive electrode composition (1). The results are shown in Table 2.

### Comparative Example 4-2

To a binder D (1.25 g), LiNi_{0.5}Co_{0.2}Mn_{0.3}O₂ (2.70 g) and acetylene black HS-100 (0.151 g) were added, and the resulting material was taken as a mixed dispersion liquid. N-methylpyrrolidone (1.46 g) was further added thereto and mixed to obtain a positive electrode composition (4).

An electrode and a coin cell were manufactured and evaluated in the same manner as in Example 4-1 except that the positive electrode composition (4) was used in place of the positive electrode composition (1). The results are shown in Table 2.

TABLE 2

| | | | | Comparative | Comparative |
|---|---|---|---|---|---|
| | | Example 4-1 | Example 4-2 | Example 4-1 | Example 4-2 |
| Active material | LiNi_{0.5}Co_{0.2}Mn_{0.3}O₂ | 65/93 | 65/93 | 60/93 | 49/90 |
| Conductive | Acetylene black | 3.5/5.0 | 3.5/5.0 | 3.2/5.0 | 2.7/5.0 |
| auxiliary agent | | | | | |
| Binder | Kind of binder | Binder A2 | Binder B2 | Binder C | Binder D |
| | Amount of addition | 1.3/1.9 | 1.3/1.8 | 1.3/2.0 | 2.7/5.0 |
| Solvent | Water [mass %] | 30 | 31 | 36 | 0 |
| | NMP [mass %] | 0 | 0 | 0 | 46 |

| | | | | |
|---|---|---|---|---|
| Solid content proportion of positive | 70 | 69 | 64 | 54 |
| electrode composition [mass %] | | | | |
| Uniformity of coating film | Good | Good | Poor | Good |
| Environmental compliance | Good | Good | Good | Poor |
| Manufacturing cost | Good | Good | Good | Poor |
| Retention rate [%] | 98 | 59 | 66 | 14 |
| Discharge capacity [mAh/g] | 171 | 173 | 168 | 167 |
| Rate characteristics [%] | 86 | 86 | 79 | 86 |

In Table 2, items of the active material, the conductive auxiliary agent and the binder each represent a ratio: (a content proportion (mass %) in a positive electrode composition)/(a content proportion (mass %) in a solid content). For example, a content proportion of acetylene black in the positive electrode composition in Example 4-1 is 3.5 mass %, and a content proportion of acetylene black in the solid content in the positive electrode composition in Example 4-2 is 5.0 mass %.

Moreover, an item of the solvent in Table 2 each represent a content proportion (mass %) of the solvent in the positive electrode composition.

In Table 2, capability of using water as the solvent leads to reduction of an environmental load and reduction of a solvent recovery cost in comparison with the case where the organic solvent is used. Accordingly, environmental compliance in Examples 4-1 and 4-2 was evaluated as “good,” and environmental compliance in Comparative Example 4-2 was evaluated as “poor.”

Moreover, from a viewpoint of a solvent cost or the solvent recovery cost in manufacture, a manufacturing cost of the positive electrode composition in Examples 4-1 and 4-2 in which water was used as the solvent was evaluated as “good.” In the positive electrode composition in Comparative Example 4-2 in which NMP was used as the solvent, the manufacturing cost was evaluated as “poor” because of necessity of recovering the organic solvent.

It is found that substantially equivalent characteristics are exhibited in initial discharge capacity between Example 4-1 and Example 4-2, and Comparative Example 4-1 and Comparative Example 4-2, respectively.

The rate characteristics are 86% and 86% in Examples 4-1 and 4-2, respectively, in comparison with 79% in Comparative Example 4-1. Therefore, it is found that, in Examples 4-1 and 4-2, a satisfactory electrical conduction network is formed also in an electrode manufacturing process using water by satisfactory dispersibility of the binder.

### Example 4-3

As a binder, powdery poly-γ-glutamic acid (made by Wako Pure Chemical Industries, Ltd., for biochemistry, weight-average molecular weight: 1,500,000 to U.S. Pat. No. 2,500,000 (PEG equivalent)) (0.06 g) was used, and LiNi_{0.8}Co_{0.15}Al_{0.05}O₂ (2.79 g) and acetylene black HS-100 (made by Denka Company Limited) (0.150 g) were added thereto, and the resulting material was taken as a powder mixture. Water (1.3 g) was further gradually added thereto and mixed to obtain a positive electrode composition (5).

The above-described poly-γ-glutamic acid (made by Wako Pure Chemical Industries, Ltd., for biochemistry, average molecular weight: 1,500,000 to 2,500,000) itself had low solubility in water and no dispersibility, but satisfactory dispersibility similar to dispersibility of the binder A2 or the binder B2 was obtained by being neutralized with alkali of the active material.

An electrode and a coin cell were manufactured and evaluated in the same manner as in Example 4-1 except that the positive electrode composition (5) was used in place of the positive electrode composition (1). The results are shown in Table 3. On the occasion, evaluation was performed on the presumption that LiNi_{0.8}Co_{0.15}Al_{0.05}O₂ has capacity of 190 mAh per 1 g.

It is considered that a satisfactory dispersing effect was obtained in the positive electrode composition (5), in which the active material and the conductive auxiliary agent were satisfactorily dispersed therein, and the binder was neutralized with an excessive alkaline component contained in the active material, and dissolved into a state in which polyglutamic acid was partially neutralized with lithium carbonate or lithium hydroxide.

### Examples 4-4

To a binder B2 (0.477 g), LiNi_{0.8}Co_{0.15}Al_{0.05}O₂ (2.70 g) and acetylene black HS-100 (made by Denka Company Limited) (0.150 g) were added, and the resulting material was taken as a mixed dispersion liquid. Water (1.3 g) was further gradually added thereto and mixed, and then lithium dihydrogen phosphate (0.06 g) was added thereto and uniformly mixed to obtain a positive electrode composition (6).

An electrode and a coin cell were manufactured and evaluated in the same manner as in Example 4-1 except that the positive electrode composition (6) was used in place of the positive electrode composition (1). The results are shown in Table 3.

The positive electrode composition (6) was satisfactorily dispersed even after adding acid, and a uniform electrode was able to be manufactured.

### Example 4-5

As a binder, poly-γ-glutamic acid (made by Wako Pure Chemical Industries, Ltd., for biochemistry, weight-average molecular weight: 1,500,000 to U.S. Pat. No. 2,500,000 (PEG equivalent)) (0.011 g) and powder (0.049 g) in which poly-γ-glutamic acid (made by Wako Pure Chemical Industries, Ltd., for biochemistry, average molecular weight: 1,500,000 to 2,500,000) was completely neutralized with sodium hydroxide and dried were used, and LiNi_{0.5}Co_{0.2}Mn_{0.3}O₂ (2.79 g) and acetylene black HS-100 (made by Denka Company Limited) (0.150 g) were further mixed therewith, and the resulting mixture was taken as a powder mixture. To the powder mixture, water (1.3 g) was gradually added and mixed to obtain a positive electrode composition (7).

On the occasion, when elemental analysis was performed on a mixture in which poly-γ-glutamic acid and neutralized poly-γ-glutamic acid were mixed at the same ratio, in the same manner as in Example 1-1, a degree of neutralization was 82%.

An electrode and a coin cell were manufactured and evaluated in the same manner as in Example 4-1 except that the positive electrode composition (7) was used in place of the positive electrode composition (1). The results are shown in Table 3.

### Example 4-6

To a binder B2 (0.852 g), graphite (2.85 g) was add to prepare a mixed dispersion liquid. Further, water (2.30 g) was added thereto to obtain a negative electrode composition (1). The positive electrode composition (1) obtained was applied onto 11 μm-thick Cu foil by using

Micrometer Adjustable Film Applicator (SA-204, made by Tester Sangyo Co., Ltd.) and Auto Film Applicator (PI-1210, made by Tester Sangyo Co., Ltd.), and the resulting material was dried at 60° C. for 10 minutes, dried in vacuum at 120° C. for 5 hours, and then pressed at room temperature to prepare an electrode having capacity of 1.5 mAh/cm² and porosity of 25 to 35%.

The electrode obtained was punched into a sheet having a diameter of 14 mm and dried in vacuum at 120° C. for 5 hours, and the resulting material was taken as a negative electrode.

In an Ar-filled glove box in which an oxygen concentration was controlled to be 10 ppm or less and a moisture concentration was controlled to be 5 ppm or less, a gasket was fitted to a positive electrode can of a coin cell (Coin Cell 2032, made by Hohsen Corporation), a negative electrode being a working electrode manufactured and a separator were laminated in this order, and an electrolytic solution was added thereto. Further, Li metal serving as a counter electrode, a SUS spacer, a wave washer, and a negative electrode can were stacked, and the resulting material was sealed with a coil cell crimper (made by Hohsen Corporation) to prepare a coin cell.

It should be noted that each component of the coin cell is as described below:

### Each Component of Coin Cell

Negative electrode: a sheet having a diameter of 14 mm manufactured as described above

Separator: a glass separator having a diameter of 16 mm (made by Advantech Toyo Co., Ltd. GA-100)

Counter electrode combined with reference electrode: Li foil having a diameter of 15 mm

Electrolytic solution: 1 mol/L LiPF₆ EC/DEC=3/7 (made by Kishida Chemical Co., Ltd.)

Discharge capacity being charge and discharge characteristics of the coin cell obtained was evaluated under the following measurement conditions. The results are shown in Table 4. In the discharge capacity evaluated, irreversible capacity of first charge and discharge was large under the following conditions, and therefore discharge capacity in a second cycle was adopted. As the rate characteristics, a capacity retention ratio (%) in 5 C was shown by presuming discharge capacity in 0.1 C as 100%.

It should be noted that battery capacity was calculated on the presumption of 360 mAh per 1 g of graphite, and 1 C (a current value completely discharged in one hour) was calculated based on the capacity.

### Measurement Conditions:

Temperature: 30±5° C.

Initial Charge and Discharge

Charge conditions: 0.1 C-CC⋅CV

Charge end conditions: voltage: 0.01 V and current value: 0.02 C or less

Discharge conditions: 0.1 C-CC

Discharge end conditions: voltage: 1.0 V

Evaluation of Rate Characteristics

Charge conditions: 0.1 C-CC⋅CV

Charge end conditions: voltage: 0.01 V and current value: 0.02 C or less

Discharge conditions: 0.5 C-CC

Discharge end conditions: voltage: 1.0 V

Charge conditions: 0.1 C-CC⋅CV

Charge end conditions: voltage: 0.01 V and current value: 0.02 C or less

Discharge conditions: 1 C-CC

Discharge end conditions: voltage: 1.0 V

Charge conditions: 0.1 C-CC⋅CV

Charge end conditions: voltage: 0.01 V and current value: 0.02 C or less

Discharge conditions: 3 C-CC

Discharge end conditions: voltage: 1.0 V

Charge conditions: 0.1 C-CC⋅CV

Charge end conditions: voltage: 0.01 V and current value: 0.02 C or less

Discharge conditions: 5 C-CC

Discharge end conditions: voltage: 1.0 V

The results are shown in Table 2-2.

### Example 4-7

To a binder B2 (0.852 g), a silicon-carbon composite active material (D₅₀=12.7 μm) (0.90 g) and graphite (2.10 g) were added, and the resulting material was taken as a mixed dispersion liquid. Further, water (2.30 g) was added thereto to obtain a negative electrode composition (2).

An electrode and a coin cell were manufactured and evaluated in the same manner as in Example 4-6 except that the negative electrode composition (2) was used in place of the negative electrode composition (1). The results are shown in Table 4. On the occasion, rate characteristics were calculated by presuming capacity of the silicon-carbon composite active material as 1000 mAh/g.

### Example 4-8

To a binder B2 (0.852 g), Li₄Ti₅O₁₂ (hereinafter, described as LTO) (2.7 g) and acetylene black HS-100 (made by Denka Company Limited) (0.150 g) were added, and the resulting material was taken as a mixed dispersion liquid. Further, water (2.30 g) was added thereto to obtain a negative electrode composition (3).

The negative electrode composition (3) obtained was applied onto 20 μm-thick Al foil by using Micrometer Adjustable Film Applicator (made by Tester Sangyo Co., Ltd., SA-204) and Auto Film Applicator (made by Tester Sangyo Co., Ltd., PI-1210), and the resulting material was dried at 60° C. for 10 minutes, and dried in vacuum at 120° C. for 5 hours, and then pressed at room temperature to prepare an electrode having capacity of 1.5 mAh/cm² and porosity of 25 to 35%.

The electrode obtained was punched into a sheet having a diameter of 14 mm, and dried in vacuum at 120° C. for 5 hours, and the resulting material was taken as a negative electrode.

A coin cell was manufactured and evaluated in the same manner as in Example 4-6 except that the above-described negative electrode was used as a negative electrode. The results are shown in Table 4. On the occasion, evaluation was performed with adjusting capacity of LTO being 175 mAh/g, lower limit voltage being 1.0 V and upper limit voltage being 2.5 V.

### Comparative Example 4-3

To a binder, commercially available sodium polyglutamate neutralized by 98% (made by Vedan Enterprise Corporation, γ-Polyglutamic Acid (Na+ form, HM)) (0.15 g) and graphite (2.85 g) were added, and the resulting material was taken as a powder mixture. Further, water (3.0 g) was added thereto to obtain a negative electrode composition (4).

An electrode and a coin cell were manufactured and evaluated in the same manner as in Example 4-6 except that the negative electrode composition (4) was used in place of the negative electrode composition (1). The results are shown in Table 4.

### Comparative Example 4-4

To a binder, commercially available sodium polyglutamate neutralized by 98% (made by Vedan Enterprise Corporation, γ-Polyglutamic Acid (Na+ form, HM)) (0.15 g), Li₄Ti₅O₁₂ (hereinafter, described as LTO) (2.7 g) and acetylene black HS-100 (made by Denka Company Limited) (0.150 g) were added, and the resulting material was taken as a powder mixture. Further, water (3.0 g) was added thereto in several portions, and the resulting mixture was mixed and dispersed thereinto to obtain a negative electrode composition (5).

An electrode and a coin cell were manufactured and evaluated in the same manner as in Example 4-8 except that the negative electrode composition (5) was used in place of the negative electrode composition (3). The results are shown in Table 4. On the occasion, corrosion of aluminum, which was not observed in Example 4-8, presumably caused by alkali eluted from the active material, was observed.

TABLE 3

| | | Example 4-3 | Example 4-4 | Example 4-5 |
|---|---|---|---|---|
| Active material | LiNi_{0.8}Co_{0.15}Al_{0.05}O₂ | 93 | 90 | — |
| | LiNi_{0.5}Co_{0.2}Mn_{0.3}O₂ | — | — | 90 |
| Conductive | Acetylene black | 5 | 5 | 5 |
| auxiliary agent | | | | |
| Binder | Kind of binder | Poly-γ-glutamic acid | Binder B2 | Poly-γ-glutamic acid/ |
| | | | | sodium poly-γ-glutamate |
| | Amount of addition | 2 | 3 | 5 |
| Acid | Lithium dihydrogen phosphate | — | 2 | — |

| | | | |
|---|---|---|---|
| Solid content proportion of positive | 70 | 70 | 70 |
| electrode composition [mass %] | | | |
| Uniformity of coating film | Good | Good | Good |
| Environmental compliance | Good | Good | Good |
| Manufacturing cost | Good | Good | Good |
| Discharge capacity [mAh/g] | 189 | 188 | 172 |
| Rate characteristics [%] | 80 | 85 | 84 |

In Table 3, items of the active material, the conductive auxiliary agent and the binder represent a content proportion (mass %) in a solid content.

TABLE 4

| | | | | | Comparative | Comparative |
|---|---|---|---|---|---|---|
| | | Example 4-6 | Example 4-7 | Example 4-8 | Example 4-3 | Example 4-4 |
| Active material | Graphite | 95 | 67 | — | 95 | — |
| | Silicon-carbon | — | 29 | — | — | — |
| | composite active | | | | | |
| | material | | | | | |
| | LTO | — | — | 90 | — | 90 |
| Conductive | Acetylene black | — | — | 5 | — | 5 |
| auxiliary agent | | | | | | |
| Binder | Kind of binder | Binder B2 | Binder B2 | Binder B2 | Sodium polyglutamate | Sodium polyglutamate |
| | | | | | (degree of neutralization | (degree of neutralization |
| | | | | | 98%) | 98%) |
| | Amount of addition | 5 | 5 | 5 | 5 | 5 |

| | | | | | |
|---|---|---|---|---|---|
| Solid content proportion of negative | 50 | 50 | 50 | 50 | 50 |
| electrode composition [mass %] | | | | | |
| Corrosion of current collector | No | No | No | No | Yes |
| Discharge capacity [mAh/g] | 358 | 490 | 174 | 357 | 169 |
| Rate characteristics [%] | 86 | 84 | 89 | 79 | 70 |

In Table 4, items of the active material, the conductive auxiliary agent and the binder represent a content proportion (mass %) in a solid content.

Table 4 shows that substantially equivalent characteristics are exhibited in initial discharge capacity between Example 4-6 and Comparative Example 4-3.

The rate characteristics are 86% in Example 4-6 and 79% in Comparative Example 4-3. Moreover, satisfactory rate characteristics are exhibited to be 84% and 89% in Examples 4-7 and 4-8, respectively. Therefore, in Examples 4-6, 4-7 and 4-8, it is considered that the electrode into which the active material composed of carbon and the conductive auxiliary agent were uniformly dispersed was obtained by satisfactory dispersibility of the binder, and the satisfactory rate characteristics were obtained. Further, in Comparative Example 4-4, corrosion of the current collector is significantly observed, and the rate characteristics are also significantly deteriorated as low as 70%. In Example 4-8, while the same LTO was used for the active material, degradation such as corrosion was not observed, and therefore it is considered that a neutralizing function of the binder worked to suppress the corrosion.

### Example 5-1

Slurry was prepared by mixing 0.11 g of a binder A2, 1.00 g of LiNi_{0.5}Co_{0.2}Mn_{0.3}O₂ and 3.31 g of distilled water. As a result of measuring a value of pH immediately after preparation of the slurry, by using a pH test paper (TRITEST, made by MACHEREY-NAGEL GmbH & Co. KG.), pH was 6. Moreover, pH after elapse of one hour from preparation of the slurry was 7.

If pH is 7, Al used as a current collector is immune from being corroded.

### Example 5-2

Slurry was prepared, and pH was evaluated in the same manner as in Example 5-1 except that a binder B2 was used in place of the binder A2. As a result, pH immediately after preparation of the slurry was 6, and pH after elapse of one hour from preparation of the slurry was 7.

### Example 5-3

Slurry was prepared, and pH was measured in the same manner as in Example 5-2 except that LTO, which is a negative electrode active material, was used in place of LiNi_{0.5}Co_{0.2}Mn_{0.3}O₂. As a result, pH immediately after preparation of the slurry was 6, and pH after elapse of one hour from preparation of the slurry was 7.

### Example 5-4

Slurry was prepared, and pH was measured in the same manner as in Example 5-1 except that LiNi_{0.8}Co_{0.15}Al_{0.05}O₂ was used in place of LiNi_{0.5}Co_{0.2}Mn_{0.3}O₂ and 0.17 g of a binder B2 as a binder and 0.02 g of lithium dihydrogen phosphate were further added thereto. As a result, pH immediately after preparation of the slurry was 6, and pH after elapse of one hour from preparation of the slurry was 7.

### Comparative Example 5-1

Then, pH was evaluated in the same manner as in Example 5-1 except that a mixture of LiNi_{0.5}Co_{0.2}Mn_{0.3}O₂ and distilled water only was prepared without using the binder A2. As a result, pH immediately after preparation of the mixture was 10 to 11.

### Comparative Example 5-2

Slurry was prepared, and pH was evaluated in the same manner as in Example 5-1 except that commercially available sodium polyglutamate neutralized by 98% (made by Vedan Enterprise Corporation, γ-Polyglutamic Acid (Na+ form, HM)) was used in place of the binder A2. As a result, pH immediately after preparation of the slurry was 10 to 11. If pH is 10 or more, Al being a current collector has risk of being corroded.

It should be noted that a degree of neutralization of the above-described sodium polyglutamate was confirmed by elemental analysis in the same manner as in Example 1-1.

As described above, the present invention has been described by a number of embodiments and Examples, but the present invention is not limited thereto, and numerous modifications can be made within the scope of the spirit of the present invention. The present invention covers a structure substantially same with the structure described in the embodiment (the same structure in functions, methods, and results, or the same structure in objectives and effects). Moreover, the present invention covers a structure in which a non-essential part described in the embodiment described above is replaced by any other structure. Further, the present invention also covers a structure according to which the same working effect can be produced or the same objective can be achieved as in the structure described in the embodiment described above. Furthermore, the present invention also covers a structure formed by adding a publicly-known technique to the structure described in the embodiment described above.

For example, the Examples have been described by way of the binder for the positive electrode and the binder for the negative electrode for the lithium-ion secondary battery, but the present invention is not limited thereto. The binder according to the present invention can be preferably used as a binder for any other electrochemical element, such as a binder for a negative electrode for the lithium-ion battery, a binder for a separator coat for the lithium-ion battery, and a binder for an electric double-layer capacitor. In particular, the binder according to the present invention can be preferably used for any other electrical device that is exposed to an oxidation environment, such as the binder for the separator coat for the lithium-ion battery or the binder for the capacitor.

The electrochemical element such as the lithium-ion battery, and the electric double-layer capacitor, manufactured by using the binder according to the present invention, can be used for various electrical devices and vehicles. Specific examples of the electrical device include a cellular phone and a laptop computer, and specific examples of the vehicle include an automobile, a railroad vehicle, and an airplane, but are not limited thereto.

Several embodiments and/or Examples of the invention have been described in detail above, but those skilled in the art will readily make a great number of modifications to the exemplary embodiments and/or Examples without substantially departing from new teachings and advantageous effects of the present invention. Accordingly, all such modifications are included within the scope of the invention.

The entire contents of the description of the Japanese application serving as a basis of claiming the priority concerning the present application to the Paris Convention are incorporated by reference herein.

1: A binder, comprising a polymer having both an anionic unit and a nonionic unit,
wherein a part of the anionic unit is neutralized, and a degree of neutralization of the anionic unit in the polymer is 95% or less.

2: The binder element according to claim 1, wherein the anionic unit is a carboxyl group, a sulfo group, a phosphonate group, a phosphinate group or a phosphate group.

3: The binder according to claim 1, wherein a cation that neutralizes the anionic unit is an alkali metal ion or an alkaline earth metal ion.

4: The binder according to claim 1, wherein the nonionic unit is an ester bond of a carboxyl group, a sulfo group, a phosphonate group or a phosphinate group, a carboxylic acid amide bond, a hydroxy group or an ether bond.

5: The binder according to claim 1, wherein a mole ratio of the anionic unit to the nonionic unit is from 2:8 to 8:2.

6: The binder according to claim 1, wherein the polymer is a polymer having an anionic unit and a nonionic unit in a same repeating unit, and the same repeating unit occupies 50% or more of all the repeating units.

7: The binder according to claim 1, wherein a repeating unit containing an aromatic hydrocarbon group contained in the polymer occupies 20% or less of all the repeating units.

8: The binder according to claim 1, wherein the polymer is a polyamide containing a repeating unit having a carboxylic acid amide bond.

9: The binder according to claim 1, wherein the polymer is a polymer containing a repeating unit represented by formula (1): 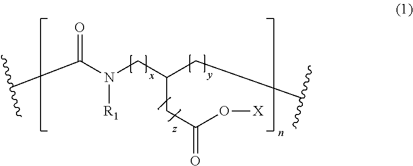
wherein x is an integer of 0 or more and 5 or less, y is an integer of 1 or more and 7 or less, and z is an integer of 0 or more and 5 or less;
X is a hydrogen ion, an alkali metal ion or an alkaline earth metal ion;
R₁ is a hydrogen atom or a functional group having 10 or less carbon atoms; and
n is a repeating number.

10: The binder according to claim 1, wherein the polymer is a polymer containing 50% or more of a repeating unit composed of amino acid or a neutralized product of amino acid.

11: The binder according to claim 1, wherein 50% or more of the repeating unit of the polymer is a polymer composed of glutamic acid or a neutralized product of glutamic acid, or aspartic acid or a neutralized product of aspartic acid.

12: The binder according to claim 1, wherein the polymer is poly-γ-glutamic acid or a neutralized product of poly-γ-glutamic acid.

13: The binder according to claim 1, wherein a weight-average molecular weight (Mw, polyethylene glycol equivalent) of the polymer is from 50,000 to 9,000,000.

14: The binder according to claim 1, further comprising water.

15: An electrode composition, comprising the binder according to claim 1.

16: An electrode, comprising the binder according to claim 1.

17: An electrochemical element, comprising the binder according to claim 1.

18: The electrochemical element according to claim 17, wherein the electrochemical element is a lithium-ion battery comprising the binder in one or more selected from an electrode, a separator protective layer and an electrode protective layer, or is an electric double-layer capacitor comprising the binder in the electrode.
